(19) United States
(12) Patent Application Publication
(10) Pub. No.: US 2014/0238622 A1
(43) Pub. Date: Aug. 28, 2014

(54) SYSTEMS AND METHODS FOR TILTING A BLIND SLAT

(71) Applicants: Don A. Patterson, Mesa, AZ (US); Kendall W. Prince, Gilbert, AZ (US); Aaron B. Dorny, Gilbert, AZ (US)

(72) Inventors: Don A. Patterson, Mesa, AZ (US); Kendall W. Prince, Gilbert, AZ (US); Aaron B. Dorny, Gilbert, AZ (US)

(21) Appl. No.: 14/012,972

(22) Filed: Aug. 28, 2013

Related U.S. Application Data
(60) Provisional application No. 61/769,019, filed on Feb. 25, 2013.

(51) Int. Cl. E06B 9/32

(52) U.S. Cl. CPC E06B 9/32
USPC 160/176.1 R; 160/405

(57) ABSTRACT

Various systems and methods for tilting a horizontal blind slat. More particularly, the present invention relates to a window covering having a lower profile head rail than is traditionally used in the industry for use with Venetian-type horizontal blind slats.

### RELATED APPLICATIONS

The present application claims priority to U.S. Provisional Patent application Ser. No. 61/769,019, filed Feb. 25, 2013 and titled LOW PROFILE HEAD RAIL, which is incorporated herein in its entirety.

### BACKGROUND OF THE INVENTION

1. Field of the Invention

The present invention relates generally to blinds or coverings for windows or for other similar openings. More particularly, the present invention relates to a window covering having a lower profile head rail than is traditionally used in the industry for use with Venetian-type horizontal blind slats.

2. Background Information

Blinds are often used to cover windows and other similar openings to provide privacy and/or to control the level of light that enters a room. A popular type of blind, sometimes called a “Venetian” blind, comprises a series of spaced-apart blind slats assembled parallel to each other. As a type of window covering, Venetian blinds offer versatility in controlling light or view and are easy to use.

A common, commercially available Venetian blind generally includes a head rail, a bottom rail, a plurality of blind slats, and a means for tilting the blind slats. Some commercially available Venetian blinds further include a means for lifting and gathering the blind slats at a position adjacent the head rail. The slats are generally suspended from the head rail via a system of cords that form a ladder. The ladder comprises forward and rearward rails that are interconnected with a plurality of rungs. Each rung of the ladder is configured to hold a blind slat at a desired distance from an adjacent blind slat. The ladder is further connected to the head rail and the bottom rail.

Tilting the blind slats causes each slat to pivot about a point on the rung. Tilting is generally accomplished via a tilting drum that is secured to a tilting rod located in the head rail. The ladder is attached perpendicularly to the tilting drum so that as the tilting rod is rotated, the tilting drum is also rotated. The forward and rearward rails of the ladder are coupled to the tilting drum such that as the tilting drum rotates, the vertical positions of the forward and rearward rails are adjusted up and down. This up and down movement tilts the rungs of the ladder, thereby tilting the blind slats supported thereon.

The components of the tilting means for a traditional Venetian blind can be quite complex, expensive, bulky and heavy. The head rails of traditional Venetian blinds are required to have a minimum size necessary to accommodate the various components to achieve tilting. For example, the tilting drum of a traditional Venetian blind must comprise a diameter with a ratio to the width of a blind slat that is large enough to accommodate complete rotation of the blind slat. Thus, the head rail must have a minimum width and height that is approximately equal to the width of the blind slat. This generally provides a head rail that may be large and bulky. A valance is commonly used to address this issue by covering or disguising the head rail.

Further, in some instances the components utilized in the traditional tilting mechanism of traditional Venetian blinds can create a limitation or barrier to achieving superior closure of the blind. For example, the minimum width of the tilting drum may prevent complete closure of the upper-most blind slat, i.e. the blind slat that is closest to the head rail. This is due to the inability of the forward and rearward rails of the ladder to close or be brought close together sufficiently due to the required minimum width of the tilting drum. As such, light-leakage commonly occurs between the upper-most blind slat and its adjacent blind slat when the window covering is closed.

Accordingly, there is a need in the art for improved systems and methods for tilting blind slats of a horizontal blind window covering. Specifically, there is a need for a window covering system that addresses and eliminates the requirements of the complex, expensive, bulky, and heavy components of traditional Venetian blind systems. Such a window covering system is disclosed herein.

### SUMMARY OF THE INVENTION

The present invention relates generally to blinds or coverings for windows or for other similar openings. More particularly, the present invention relates to a window covering having a low profile head rail for use with Venetian-type horizontal blind slats. The low profile head rail of the present invention eliminates the traditional components of Venetian-type horizontal blinds thereby reducing the cost of production, as well as reduce the amount of metal or other materials required in the head rail. Some implementations of the present invention provide a head rail that does not require the use of a valance.

Some implementations of the present invention include a window covering having a head rail which includes a plate having a length sufficient to cover, or at least partially cover a window opening. The head rail of the present invention may include a low profile as compared to traditional, Venetian-type horizontal blinds. This is accomplished by altering or eliminating the blind tilting components of traditional Venetian-type horizontal blinds. Traditional blind tilting components are oriented in a generally vertical position thereby requiring a minimum head rail height. In contrast, the tilting components of the present invention are capable of being oriented in a generally horizontal position, thereby reducing the required minimum head rail height. Further, the tilting components of the present invention provide blind closure that is superior to achievable closure by traditional, Venetian-type horizontal blinds.

Some implementations of the present invention provide a low profile head rail device for use with a Venetian-style horizontal blind slat, the low profile head rail device having a plate having a top surface, a bottom surface, a length, and a width, wherein the plate supports or carries one or more cord drive components that are rotatably coupled to the top surface of the plate in a generally horizontal orientation. The cord drive component is fixedly coupled to an anchor end of a first and second tilt cord. A terminal end of each tilt cord is coupled to a blind slat, thereby suspending the blind slat below the plate of the head rail. In some implementations, the head rail further comprises a lift cord that is coupled to a bottom rail of the horizontal blind to facilitate lifting of the plurality of blind slats.

The head rail may include a belt drive which is coupled to the cord drive component via a synchronization pulley to rotate the cord drive component in clockwise and counter-clockwise directions. In some implementations, the cord drive component comprises a top planar surface on which a synchronization pulley is mounted or otherwise attached. The synchronization pulley comprises an annular groove in which the belt drive is seated. In some instances, the belt drive contacts and interacts with a surface of the cord drive component to rotate the cord drive component. For example, in some embodiments the belt drive contacts and interacts with a second groove located on the cord drive component. In other instances, the belt drive contacts a surface of the cord drive component, that is adjacent the groove.

One having skill in the art will appreciate that the cord drive components of the instant invention may be driven by any method and/or device known in the art. For example, in some instances the cord drive components are driven directly, such as by a worm gear that contacts a complementary set of gear teeth on the cord drive component. As the worm gear is rotated by the user, the cord drive component is also rotated. Alternatively, in some instances the cord drive components are driven indirectly, such as by a belt or chain that interconnects the cord drive component to a separate gear or drive component that is rotated directly by the user. Thus, as the user rotates the separate gear or drive component, the cord drive component is rotated via the belt or chain. Some implementations further include an opening or openings in the plate through which the first and second tilt cords are fed. In some instances, an axle is further provided to direct the first and second tilt cords through the opening without contacting a periphery of the opening. Some implementations of the present invention provide a lift cord that passes through an opening in the plate and passes through or adjacent to the blind slats and then couples to the bottom rail.

As the cord drive component is rotated in a clockwise or counter-clockwise direction, the first and second tilt cords are either wound onto the cord drive component, or are wound off. As such the length of the tilt cords is adjusted thereby causing the blind slat to tilt in a clockwise or counter-clockwise rotation. In some instances, this movement of the first and second tilt cords allow for the cord drive component to over-rotate the blind slats in the clockwise or counter-clockwise direction. The over-rotation of the blind slats is characterized by one tilt cord being overly wound onto the cord drive component while the other tilt cord is unwound from the cord drive component, thereby resulting in the unwound tilt cord assuming a flaccid or slack state, while the overly wound tilt cord is taut. Further, the overly wound tilt cord lifts the upper edge of the blind slat towards the head rail, thereby reducing and/or eliminating a gap between the blind slat and the head rail. Thus, superior closure of the blind slats may be accomplished without requiring the tilting components of traditional Venetian-type horizontal blind window coverings.

### BRIEF DESCRIPTION OF THE DRAWINGS

The foregoing and other objects and features of the present invention will become more fully apparent from the accompanying drawings when considered in conjunction with the following description. Although the drawings depict only typical embodiments of the invention and are thus not to be deemed as limiting the scope of the invention, the accompanying drawings help explain the invention in added detail.

FIG. 1, shown in parts A-C, shows various views of a low profile head rail and system for tilting Venetian-style horizontal blind slats, the blind slats shown in a fully-opened position in accordance with a representative embodiment of the present invention;

FIGS. 1D and 1E show various configurations of a cord drive component having a second groove or surface to receive or support a belt drive in accordance with representative embodiments of the present invention;

FIG. 1F is a top plan view of a low profile head rail having a cord drive component comprising a worm gear and a worm in accordance with a representative embodiment of the present invention

FIG. 2, shown in parts A-C, shows various views of a low profile head rail and system for tilting Venetian-style horizontal blind slats, the blind slats shown in a partially closed position in accordance with a representative embodiment of the present invention;

FIG. 3, shown in parts A-C, shows various views of a low profile head rail and system for tilting Venetian-style horizontal blind slats, the blind slats shown in a closed position in accordance with a representative embodiment of the present invention;

FIG. 4, shown in parts A-C, shows various views of a low profile head rail and system for tilting Venetian-style horizontal blind slats, the blind slats shown in an over-rotated position thereby providing superior closure of the blind slats in accordance with a representative embodiment of the present invention;

FIG. 5 shows a plan top view of a low profile head rail and system for tilting Venetian-style horizontal blind slats, the system for tilting incorporating cord guides to maintain the position of the tilt cords over the axle in accordance with a representative embodiment of the present invention;

FIG. 6, shown in parts A and B, shows various views of a low profile head rail and system for tilting Venetian-style horizontal blind slats, the head rail comprising a plurality of cord drive components, axles, belt drives, cord supports, and tilt cords in accordance with a representative embodiment of the present invention;

FIG. 6C shows a plan top view of a low profile head rail having a plurality of cord drive components interconnected via a single cam arm in accordance with a representative embodiment of the present invention;

FIG. 6D shows a side view of a low profile head rail having a plurality of cord drive components attached thereto in an inverted configuration in accordance with a representative embodiment of the present invention;

FIG. 7 shows a low profile head rail having front and rear sidewalls having a height that is approximately equal to a height of the cord drive component in accordance with a representative embodiment of the present invention;

FIG. 8 shows a plan top view of a low profile head rail comprising a belt drive in a figure-eight configuration in accordance with a representative embodiment of the present invention;

FIGS. 9A and 9B, show a low profile head rail having a plurality of cord drive components interconnected via a plurality of belt drives and tilt cords in accordance with a representative embodiment of the present invention;

FIG. 9C is a side view of a low profile head rail in an inverted configuration in accordance with a representative embodiment of the present invention;

FIG. 10 is a plan top view of a low profile head rail having a single cord drive component and a plurality of tilt cords and cord supports in accordance with a representative embodiment of the present invention;

FIGS. 11A and 11B illustrate a low profile head rail utilizing a grommet as a cord support in accordance with a representative embodiment of the present invention; and

FIGS. 12A and 12B illustrate a low profile head rail with multiple openings which the cords pass through in accordance with a representative embodiment of the present invention.

### DETAILED DESCRIPTION OF THE INVENTION

The following detailed description, in conjunction with the accompanying drawings (hereby expressly incorporated as part of this detailed description), sets forth specific numbers, materials, and configurations in order to provide a thorough understanding of the present invention. The following detailed description, in conjunction with the drawings, will enable one skilled in the relevant art to make and use the present invention.

A purpose of this detailed description being to describe the invention so as to enable one skilled in the art to make and use the present invention, the following description sets forth various specific examples, also referred to as “embodiments,” of the present invention. While the invention is described in conjunction with specific embodiments, it will be understood, because the embodiments are set forth for explanatory purposes only, that this description is not intended to limit the invention to these particular embodiments. Indeed, it is emphasized that the present invention can be embodied or performed in a variety of ways. The drawings and detailed description are merely representative of particular embodiments of the present invention.

As used herein, the term “cord drive component” is understood to include any device or combination of devices which are configured to facilitate movement of tilt cords to rotate a blind slat. For example, a cord drive component may include a pulley, a cam, a lever arm, a gear, a gear box, a bar, a friction device, a spring or cord lock and combinations thereof.

As used herein, the term “cord support” is understood to include any device or combination of devices configured to prevent contact between a tilt cord and the plate of a low profile head rail. For example, a cord support may include a grommet, an axle, a pulley, a post, an eyelet, a guide wheel, and combinations thereof. In some instances, a cord support may be placed directly in contact with an opening in the plate to serve as a barrier between a tilt cord and the plate.

One having skill in the art will appreciate that the embodiments shown and discussed herein comprise various components that may be scaled and adjusted as needed to accommodate blind slats of desired widths, lengths and thicknesses. For example, the embodiments shown and discussed herein may be scaled for use with a 0.5 inch blind slat, a 1.0 inch blind slat, a 1.5 inch blind slat, a 2.0 inch blind slat, and/or a 3.0 inch blind slat. Alternatively, the embodiments shown and discussed herein may be scaled to any desired dimensions. Further, the embodiments shown and discussed herein may comprise any length sufficient to cover or partially cover a window opening, as may be desired. One having skill in the art will further appreciate that the embodiment shown and discussed herein may include any number of cord drive components, cord supports, belt drives, ladders, lift cords, and other components that may be desired or required to accommodate a blind slat having a desired shape, width and/or length.

Reference will now be made in detail to several embodiments of the invention. The various embodiments will be described in conjunction with the accompanying drawings wherein like elements are designated by like numeric characters throughout.

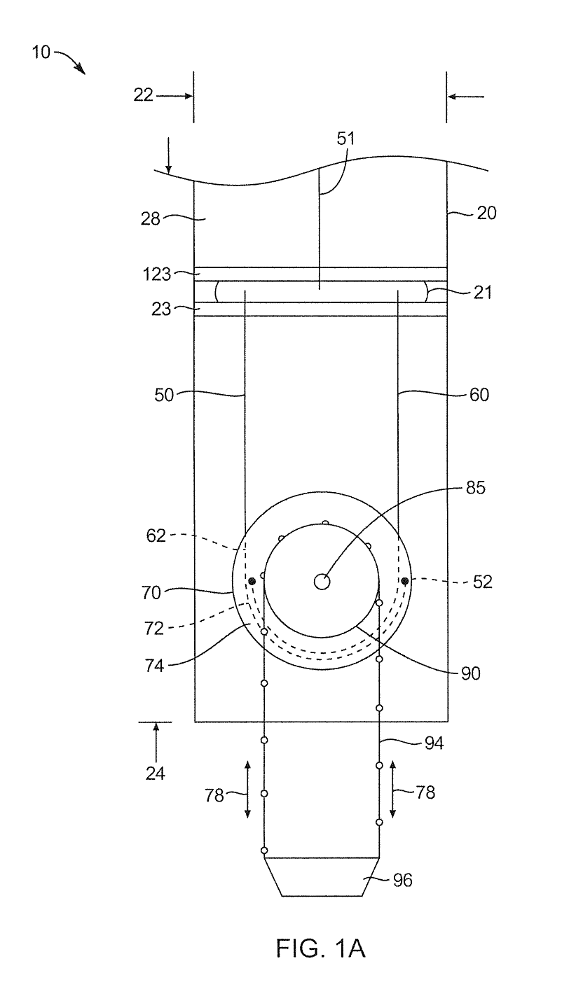

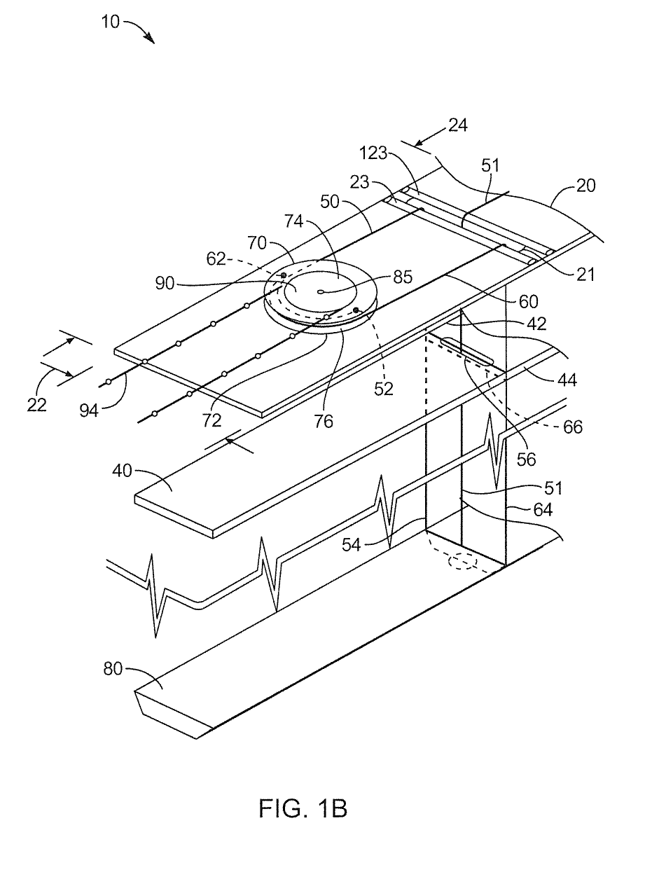

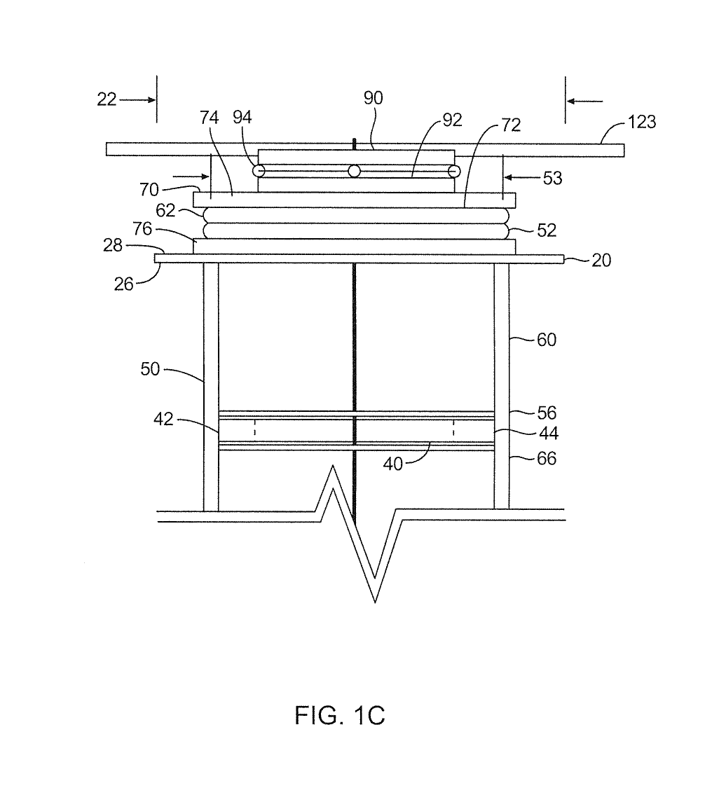

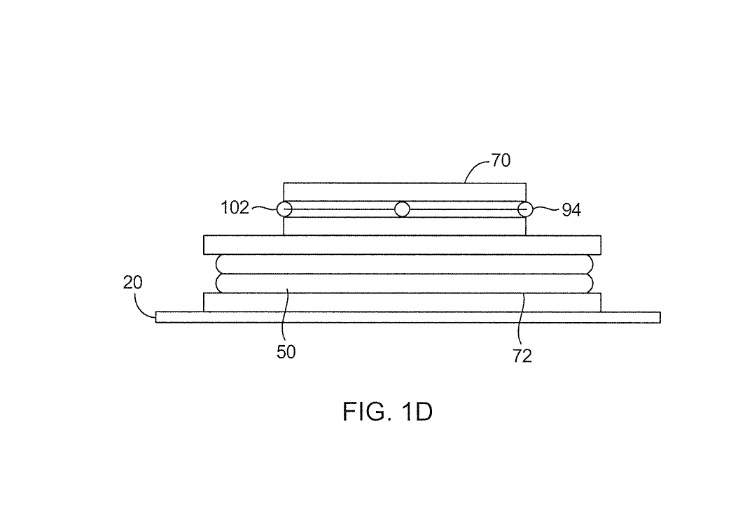

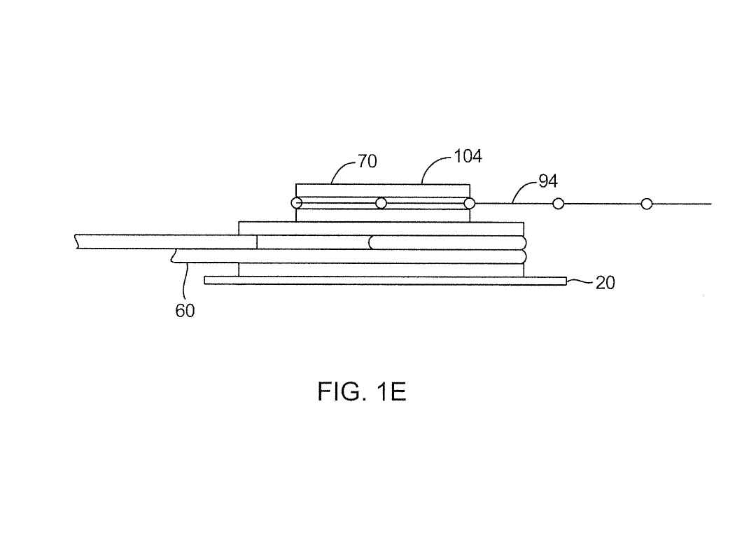

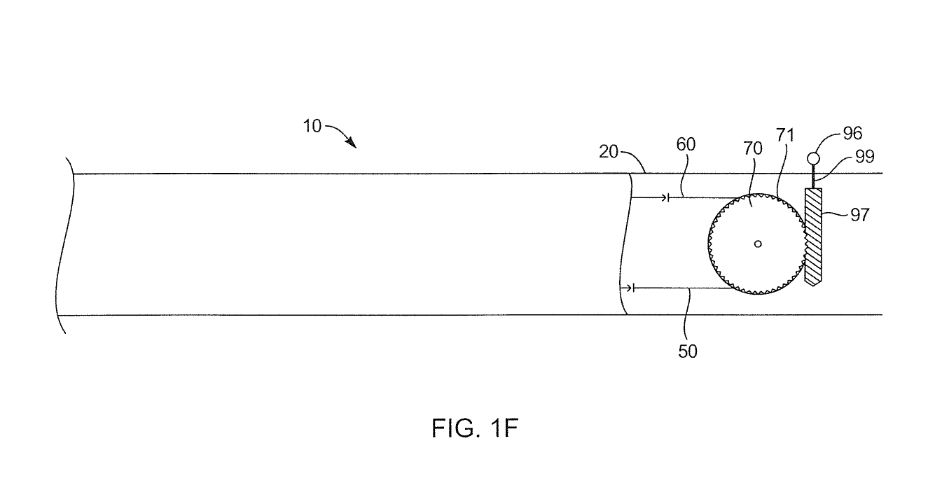

Referring now to FIGS. 1A-1C, a low profile head rail 10 is shown. Low profile head rail 10 generally comprises a plate 20 having a width 22 and a length 24 sufficient to support a blind slat 40 having approximately equal dimensions. In some instances, length 24 is selected to be approximately equal to the width of a window opening, such that head rail 10 spans the distance across the width of a window opening. However, length 24 may comprise any value. In some instances, length 24 is selected to partially span a window opening. In other embodiments, length 24 is selected to be greater than the width of a window opening, wherein plate 20 is secured to the window opening with an outside mount. In other instances, length 24 is selected to cover a window that is part of a door, or another non-traditional type of window. Head rail 10 may further be used in combination with another type of traditional window covering, such as a set of curtains or a pull shade.

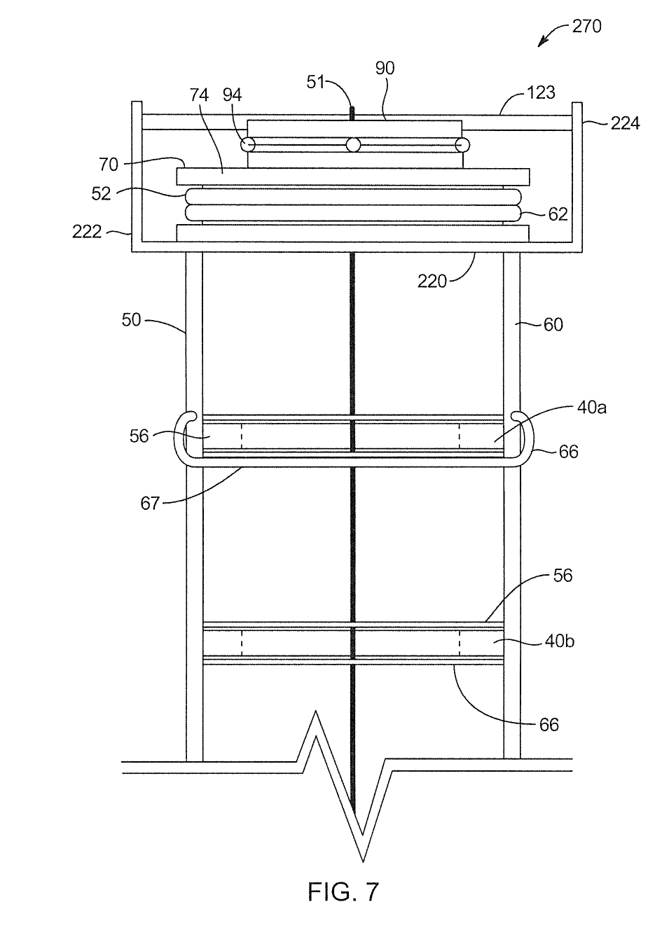

Plate 20 may further comprise any material that is compatible for use in supporting horizontal blind slats 40. For example, in some embodiments plate 20 comprises a metallic material, such as steel or aluminum. Plate 20 may further include a polymer material, such as polystyrene, polyurethane, polycarbonate, and polyvinylchloride. In some instances, plate 20 comprises a wood material. In some instance, plate 20 comprises a combination of materials. Where plate 20 comprises front and rear sidewalls, plate 20 may be formed by bending the metallic material into a desired shape, or may be provided by an extrusion or molding process (see FIG. 7, below). One having skill in the art will appreciate that the teachings of the present invention are not limited to any specific material or manufacturing process, and therefore may be applied and incorporated into any compatible material and its respective manufacturing process.

Blind slat 40 generally comprises a horizontal blind slat, similar to blind slats that are traditionally used in Venetian-type blinds. Blind slat 40 may comprise any material. For example, blind slat 40 may include wood, metal, fabric, plastic, thermoplastic, thermoset, and composite materials, as well as any material comprising a combination of the materials stated herein. Blind slat 40 may further include any structural or ornamental configuration, as may be desired. For example, in some embodiments blind slats 40 are flat. In other embodiments, blind slats 40 comprise a crescent cross-section. Other cross-section profiles for horizontal blind slat 40 include wavy, convex, concave, rectangular, ellipsoid, and double convex. Horizontal blind slats 40 may further include other design or structural features. For example, horizontal blind slats 40 may include a painted surface, embossing, a veneer, a texture, a printed design or color, a coating, or a paper covering.

Horizontal blind slats 40 generally comprise a distal edge 42, and a proximal edge 44, wherein the blind slat is positioned below the bottom surface 26 of plate 20. For purposes of describing various embodiments of the present invention, distal edge 42 is generally positioned towards a window opening when the blind slat 40 is in an open position, and proximal edge 44 is generally positioned opposite the window opening when the blind slat 40 is in an opened position.

In some embodiments, a plurality of horizontally-oriented blind slats 40 are suspended from plate 20 via a first tilt cord 50 and a second tilt cord 60. First and second tilt cords 50 and 60 may comprise any length necessary to support the suspended blind slats 40 beneath plate 20. Further, first and second tilt cords 50 and 60 may comprise any material compatible for use in a window covering. For example, in some embodiments first and second tilt cords 50 and 60 comprises a braided rope cord.

First and second tilt cords 50 and 60 each have an anchor end 52 and 62, respectively, which is fixedly coupled to an annular groove 72 of a cord drive component 70. In some embodiments, the positions at which anchor ends 52 and 62 are attached to groove 72 facilitates a desired tilting motion of blind slats 40. In some instances, the positions of anchor ends 52 and 62 within groove 72 allow for superior closure of the blind slats when the tilt cord is over-rotated in a clockwise or counter-clockwise direction.

In some embodiments, anchor end 52 of tilt cord 50 enters groove 72 on the distal side of cord drive component 70, passes around the backside of cord drive component 70, and is coupled to groove 72 on the proximal side of cord drive component 70. Similarly, anchor end 62 of tilt cord 60 enters groove 72 on the proximal side of cord drive component 70, passes around the backside of cord drive component 70, and is coupled to groove 72 on the distal side of cord drive component 70. This configuration results in a portion of tilt cord 50 adjacent to a portion of tilt cord 60 at the backside of cord drive component 70.

The precise positions of anchor ends 52 and 62 may be adjusted within groove 72 as desired. The positions may be varied based upon the circumference, shape and position of the cord drive component. In some embodiments, the positions of anchor ends 52 and 62 within groove 72 are selected to maintain a constant distance 53 between tilt cords 50 and 60 when cord drive component 70 is rotated in clockwise and counter-clockwise directions. In some embodiments, distance 53 is approximately equal the width of groove 72 as measured across pivot point 85 of cord drive component 70. Thus, when cord drive component 70 is maximally over-rotated in a clockwise direction, anchor end 52 is repositioned to the proximal side of cord drive component 70, but does not rotate to the front-side of cord drive component 70. The clockwise over-rotation of cord drive component 70 further winds additional lengths of tilt cord 60 onto groove 72, thereby drawing blind slat upwards towards plate 20 to provide superior closure of the blind.

In some embodiments, the annular shape of groove 72 comprises a circle, such that distance 53 is constant for all positions of measurement across pivot point 85. In other embodiments, the annular shape of groove 72 comprises a non-circular shape whereby distance 53 varies for various positions of measurement across pivot point 85. For example, in some embodiments the annular shape of groove 72 is an oval. In other embodiments, the annular shape of groove 72 is rectangular. Further, in some embodiments the annular shape of groove 72 is triangular or another polygon shape. Thus, as cord drive component 70 is rotated and distance 53 is measured across pivot point 85 from a constant position, distance 53 may vary dependent upon the annular shape of groove 72.

A non-circular shape for groove 72 may be desirable to control the speed and timing for rotating blind slats 40 in response to rotating cord drive component 70. A non-circular shape for groove 72 may also be desirable achieve a smaller value for distance 53 when blind slats 40 are in a closed position, and achieve a larger value for distance 53 when blind slats 40 are in an open position. Thus, one having skill in the art will appreciate that the shape of groove 72 and/or the shape of cord drive component 70 may be adjusted to assist in achieving a desired movement of blind slats 40.

In some embodiments, the positions of anchor ends 52 and 62 are selected so that when cord drive component 70 is maximally over-rotated in a clockwise direction, anchor end 52 is repositioned to the front-side of cord drive component, thereby resulting in a flaccid or slack state of tilt cord 50. Similarly, the position of anchor end 62 may be selected so that when cord drive component 70 is maximally over-rotated in a counter clockwise direction, anchor end 62 is repositioned to the front-side of cord drive component 70, thereby resulting in a flaccid or slack state of tilt cord 60. The non-flaccid tilt cord is simultaneously pulled taut thereby lifting the uppermost edge of the tilted blind towards to head rail to provide superior closure of the blind.

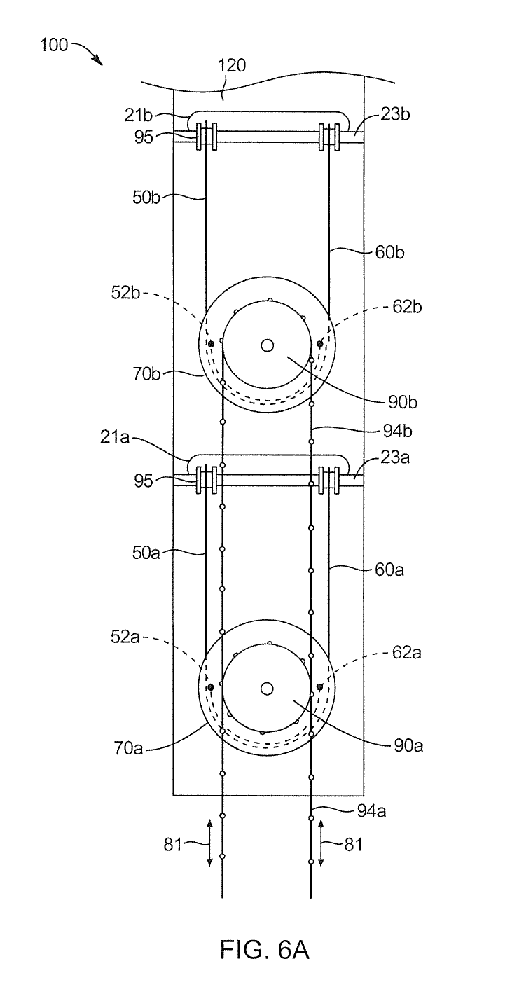

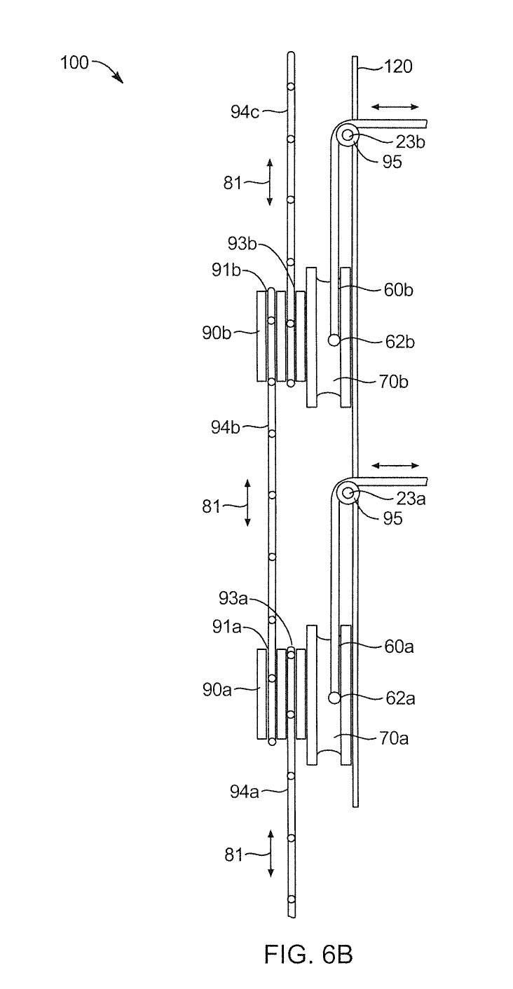

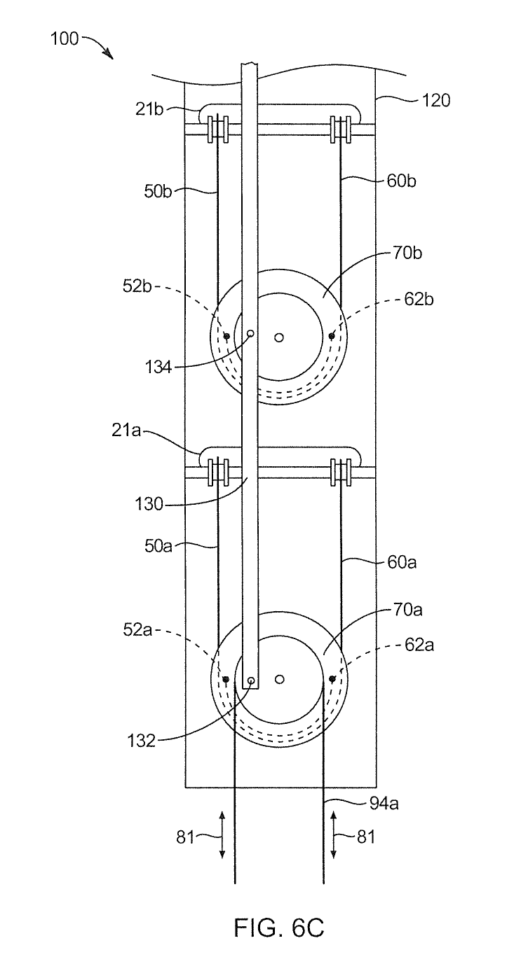

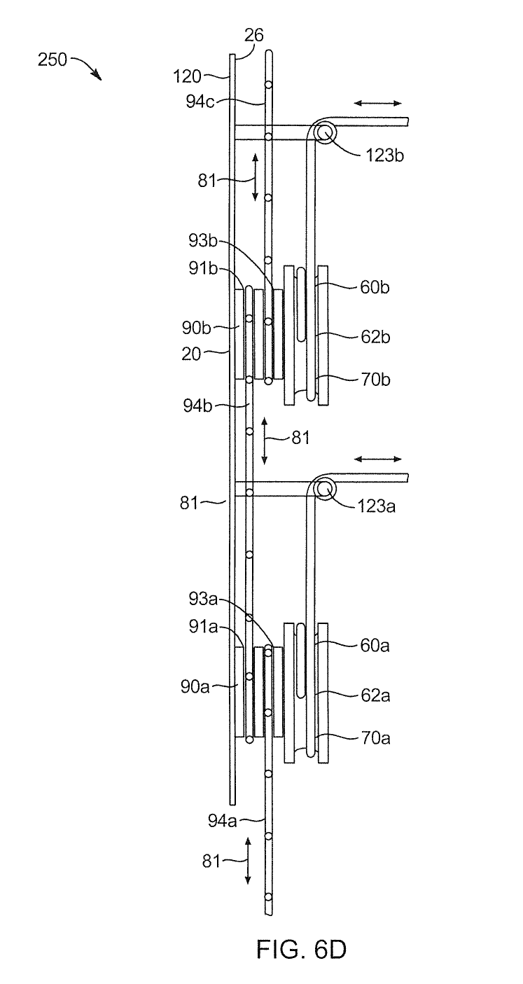

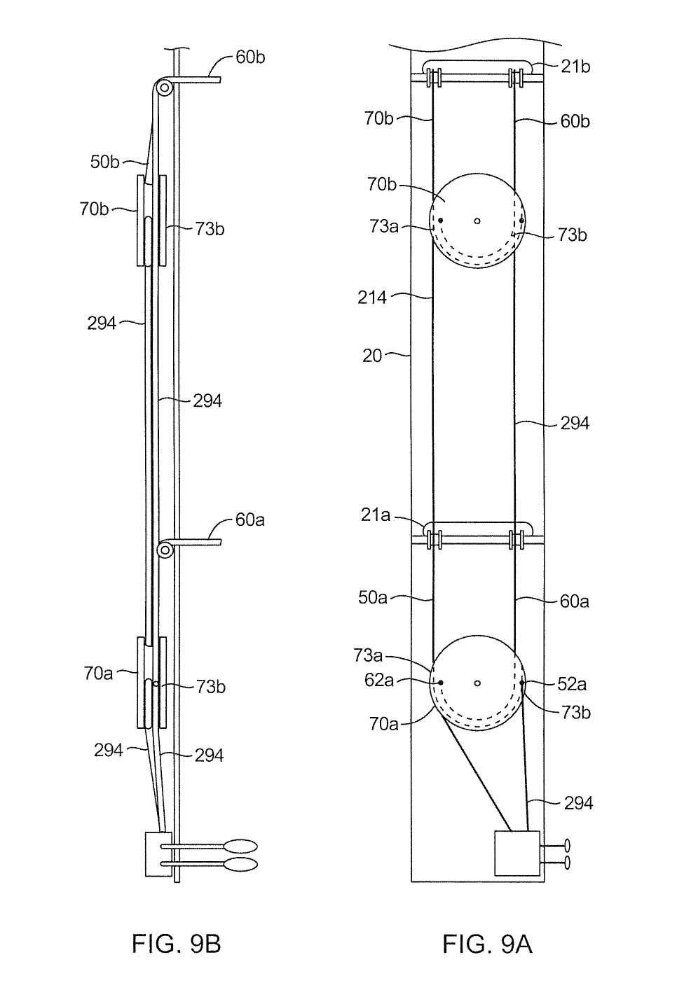

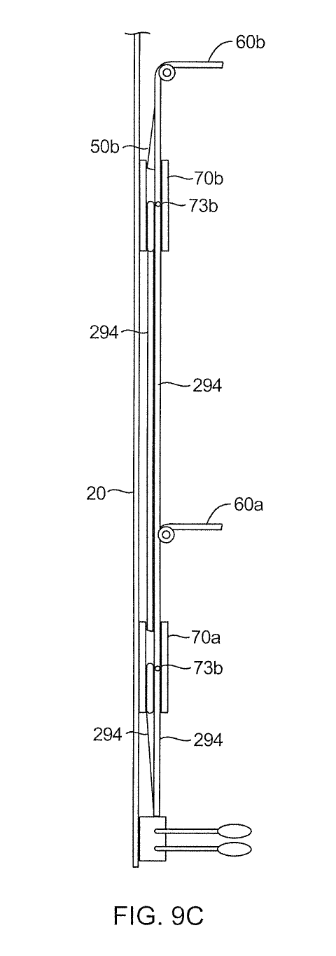

Cord drive component 70 is directly or indirectly coupled to plate 20 in a rotatable manner, and is positioned on plate 20 in a generally horizontal orientation. In some embodiments, cord drive component 70 is coupled to a top surface of plate 20, as shown. In other embodiments, cord drive component 70 is coupled to a bottom surface of plate 20, wherein all of the components of the low profile head rail 10 are located beneath plate 20 in an inverted configuration, as shown and discussed in connection with FIGS. 6D and 9C, below. Further, in some embodiments plate 20 comprises a U-channel, wherein the various components are positioned within the U-channel, as shown in FIG. 7. In some instances, the U-channel further comprises a lid or cover (not shown), whereby the various components are enclosed within the U-channel.

In some embodiments, anchor end 52 is secured at a first position within groove 72, and anchor end 62 is secured at a second position within groove 72, wherein tilt cords 50 and 60 are adjacent to one another within groove 72 at a position around the backside of cord drive component 70, wherein the first and second positions are approximately 180° apart, or positioned on approximately opposite sides of groove 72. In some instances, anchor end 52 and 62 are secured at the same position. This may be dependent upon the cord size, diameter of the drive device, and number of time the cord has been coiled around the drive device. In other instances, anchor ends 52 and 62 are positioned at any location that best allows for the management of tilt cords.

In some embodiments, tilt cord 50 abuts tilt cord 60 within groove 72. Further still, in some embodiments tilt cords 50 and 60 are independently positioned within adjacent grooves on cord drive component 70. One having skill in the art will appreciate that the diameter of the cord drive component 70 will influence the rate of tilt and number of revelations in either the clockwise or counter clockwise direction to tilt the blind slats to an open or closed position.

In some instances, anchor ends 52 and 62 are set in a neutral position when blind slats 40 are in a fully-opened orientation, as shown. A fully-opened orientation is understood to describe a tilted position of blind slat 40 wherein the plane of blind slat 40 is approximately parallel with the plane of head rail 20, and approximately perpendicular with a plane of the window opening. A neutral position of anchor ends 52 and 62 is further understood to describe a rotational position of cord drive component 70 wherein additional rotation of cord drive component 70 in either a clockwise or a counter-clockwise direction results in tilting of blind slats 40 to an orientation other than a fully-opened.

In some instances, groove 72 comprises a depth sufficient to receive tilt cords 50 and 60 when cord drive component 70 is rotated in a clockwise or counter-clockwise direction. Further, in some implementations, groove 72 comprises a depth sufficient to receive both tilt cords 50 and 60 in an overlapped configuration. For example, in some instances cord drive component 70 is over-rotated such that the anchor ends 52 and 62 are rotated more than 180° from their initial, neutral position. As such, one of the anchor ends is rotated under the middle of the other tilt cord within groove 72. Accordingly, some pulleys of the present invention comprise a groove having a sufficient depth to receive both tilt cords in an overlapped configuration. In other embodiments, groove 72 comprises a width sufficient to receive tilt cords 50 and 60 in an abutted manner, whereby tilt cords 50 and 60 are prevented from overlapping when cord drive component 70 is rotated.

Cord drive component 70 may comprise any material that is compatible for use in a window covering. In some embodiments, cord drive component 70 comprises a plastic material, such as nylon. In other embodiments it may be comprised by other thermoplastic materials or out of metals. Some implementations of cord drive component 70 comprise a top planar surface 74 and a bottom planar surface 76 with groove 72 being positioned therebetween. Cord drive component 70 is oriented in a horizontal configuration such that bottom planar surface 76 is oriented towards top surface 28 of plate 20, and cord drive component 70 is capable of being rotated in a plane that is parallel to the plane of top surface 28. Cord drive component 70 is rotatably coupled to plate 20 via a pivot point or bearing 85, such that cord drive component 70 may be rotated about a center axis of cord drive component 70 in clockwise and counter-clockwise directions.

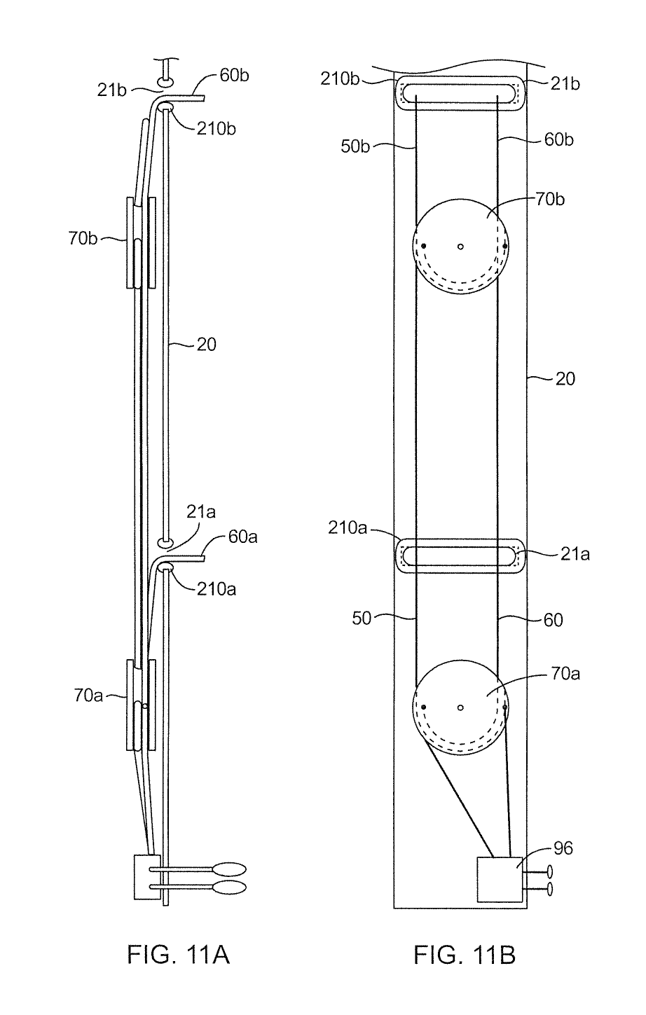

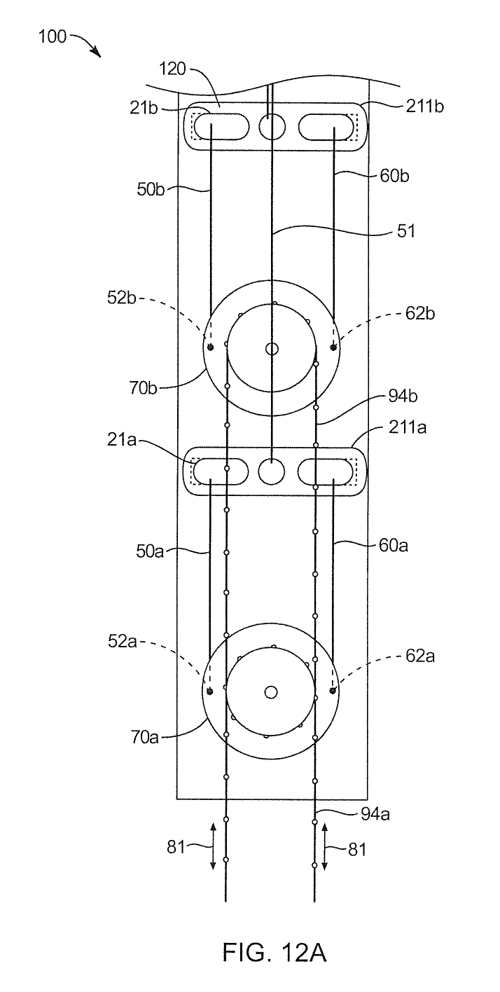

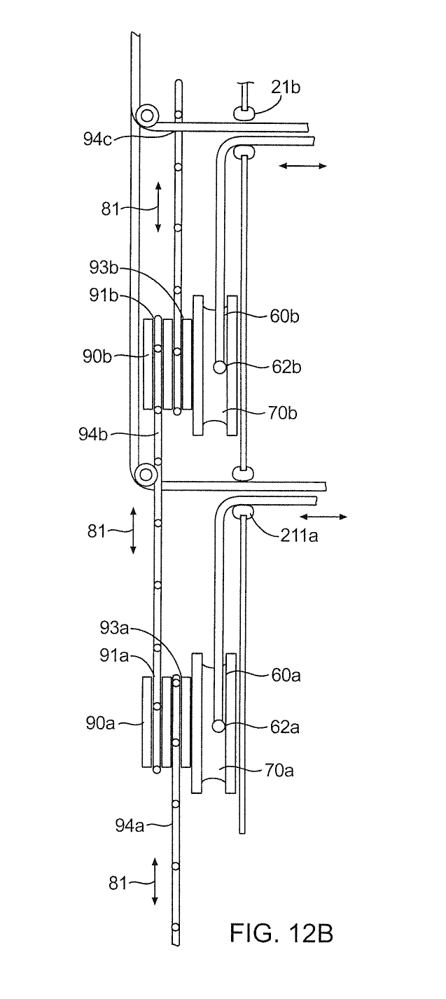

Tilt cords 50 and 60 further comprise terminal ends 54 and 64, respectively, which are positioned below plate 20 and coupled to a bottom rail 80. In some instances, plate 20 comprises an opening 21 through which tilt cords 50 and 60 are passed. Opening 21 generally comprises a width and length sufficient to permit unencumbered passage of tilt cords 50 and 60. In some embodiments, plate 20 further comprises a cord support, such as an axle 23 which is positioned approximate to opening 21 and comprises a surface over which tilt cords 50 and 60 pass. Axle 23 may be positioned near opening 21 such that tilt cords 50 and 60 are passed over axle 23 and through opening 21 without contacting the periphery of opening 21. In this manner, damage to tilt cords 50 and 60 due to contact with opening 21, is prevented. Alternatively, in some embodiments plate 20 comprises a cord support comprising a grommet that is inserted into opening 21 and is provided to support tilt cords 50 and 60 as they pass through opening 21, in either a single opening as shown in FIGS. 11A and 11B, or through multiple openings as is illustrated in FIGS. 12A and 12B. In some instances, a grommet is provided that comprises a low-friction material, such as nylon or Teflon®. Also, in some embodiments it may include more than one cord support per opening.

In some embodiments, tilt cords 50 and 60 further comprise middle portions forming ladders on which blind slats 40 are supported. In some embodiments, the ladders comprise a top rung 56 and a bottom rung 66, wherein blind slat 40 is positioned between the top and bottom rungs. In other embodiments, the ladder comprises a single rung, wherein blind slat 40 is secured to the ladder via a retainer clip 67, as shown in FIG. 7. Generally, ladders are spaced along the middle portions of tilt cords 50 and 60 to accommodate a plurality of blind slats. In some instances, ladders are spaced so that the edges of adjacent blind slats overlap when the blind slats are tilted into a closed orientation. In this way, the closed positions of blind slats 40 prevent light from passing through the window covering, as is common with traditional Venetian-type horizontal blinds.

In some instances, cord drive component 70 further comprises a means for rotating cord drive component 70 in clockwise and counter-clockwise directions 78. This means for rotating may include any device or combination of devices capable of rotating cord drive component 70. For example, in some embodiments cord drive component 70 comprises a synchronization pulley 90 coupled to the top planar surface 74 of cord drive component 70. Synchronization pulley 90 comprises a groove 92 in which is seated a belt drive 94. In some embodiments, cord drive component 70 further comprises a second groove 102 that is adjacent groove 72 and configured to receive belt drive 94, as shown in FIG. 1D. In other embodiments, cord drive component 70 comprises a surface 104 that is adjacent groove 72 and configured to support or receive belt drive 94, as shown in FIG. 1E.

Belt drive 94 is further coupled to a rotating device 96. In some embodiments, rotating device 96 comprises a gear box. In other embodiments, rotating device 96 comprises a spring recoil pulley. Further, in some embodiments rotating device 96 comprises a third pulley around which belt drive 94 is further looped on an adjacent cord drive component. Further still, in some instances rotating device 96 is merely a cord that is grasped and manipulated by a user.

In some embodiments, an exposed, circumferential surface of cord drive component 70 comprises a set of teeth 71 forming a worm gear, as shown in FIG. 1F. The worm gear is configured to mesh with a worm 97 that is operatively connected to rotating device 96. In some instances, a wormshaft 99 of the worm is coupled to a wand 96, whereby a user rotates the wand 96 to turn the worm 97 thereby rotating the worm gear (i.e. cord drive component 70) in a clockwise and/or counter-clockwise direction. Alternatively, the wormshaft 99 of the worm 97 may be coupled to a pulley and a drive belt, drive chain, or other cord, whereby a user may turn the worm 97 and rotate the worm gear by rotating the pulley. One having skill in the art will recognize that rotating device 96 may include any number of variations within the spirit of the teachings disclosed herein. One having skill in the art will also appreciate that rotating cord drive component 70 can be accomplished in any number of variations either through direct or indirect connection with rotating device 96, as discussed above.

Some embodiments of the present invention further include a lift cord 51 that is passed through opening 21 and is attached to the bottom most blind slat and/or a bottom rail of the blind assembly. In some instances, plate 20 further comprises an axle 123 positioned proximate to opening 21 to facilitate passage of lift cord 51 through opening 21. Plate 20 may alternatively comprise a separate opening for lift cord 51. In some embodiments, lift cord 51 comprises a free end that is coupled to a retaining mechanism, such as a cord lock or other retention device as is commonly used in the art.

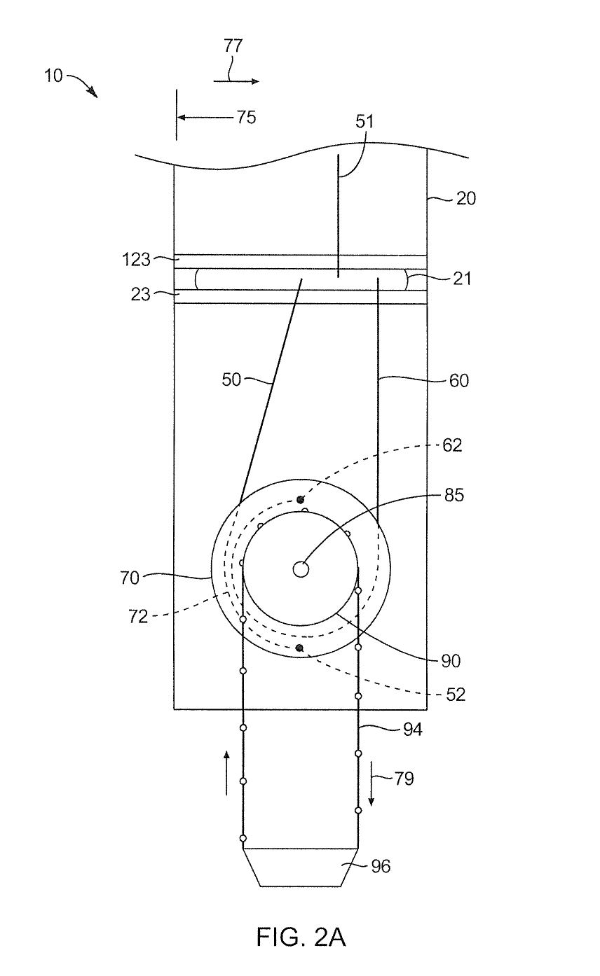

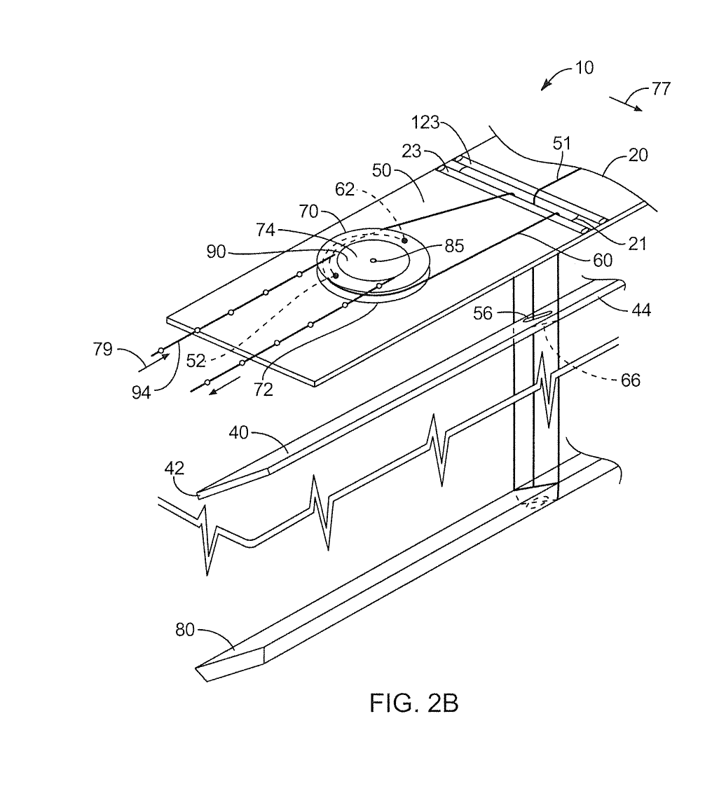

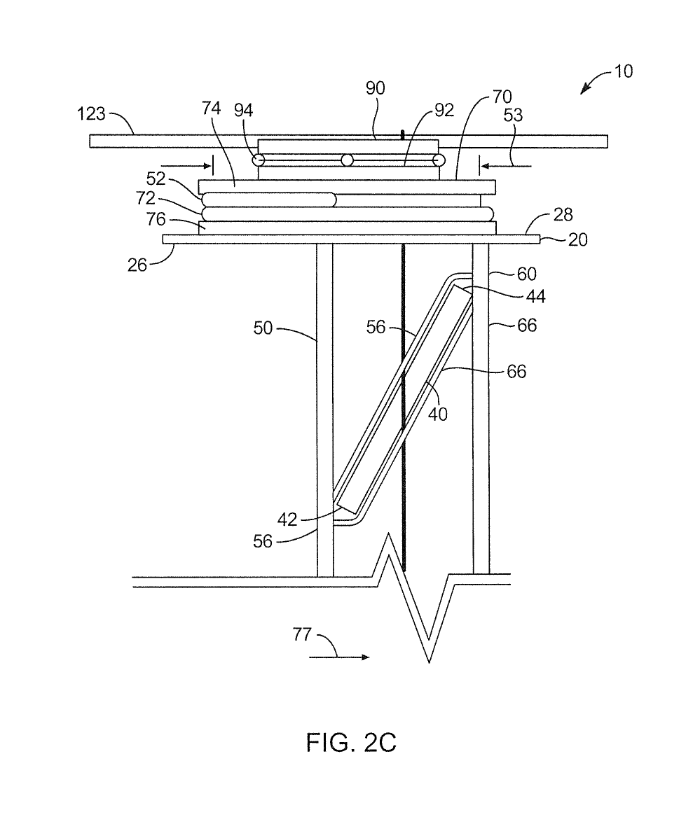

Referring now to FIGS. 2A-2C, low profile head rail 10 is shown with blind slats 40 in a partially-closed orientation, wherein cord drive component 70 has been rotated approximately 90° in a clockwise direction 79. As cord drive component 70 is rotated in clockwise direction 79, anchor end 62 is moved from a distal position (as shown in FIGS. 1A-1C) to a right-hand position, as shown in FIGS. 2A-2C. Similarly, anchor end 52 is moved from a proximal position to a left-hand position, as shown. With anchor end 52 in a left-hand position, tilt cord 50 is partially displaced from groove 72 thereby increasing the distance between distal edge 42 and plate 20. Conversely, the right-hand position of anchor end 62 results in a portion of tilt cord 60 being wound further onto cord drive component 70 thereby shortening the distance between proximal edge 44 of blind slat 40 and plate 20. The simultaneous displacement of proximal and distal edges 42 and 44 results in a partially-closed, tilted orientation of blind slats 40.

The abutted configuration of tilt cords 50 and 60 within groove 72 results in the tilt cords being spaced from one another a distance 53 which is equal to the distance between the distal and proximal apexes of groove 72 or approximately the diameter of groove 72 as measured across pivot point 85. As cord drive component 70 is rotated in clockwise direction 79, anchor end 52 is rotated to the left-hand position, and anchor end 62 is rotated to the right-hand position, as described above. In some instances, the left-hand and right-hand positions of anchor ends 52 and 62 are approximately centered between the proximal and distal apexes of groove 72. In other instances, the left-hand and right-hand positions of anchor ends 52 and 62 determined based upon different variables, such as the size of cord drive component 70 in relation to blind slat 40, and the number of times tilt cords 50 and 60 are wrapped around cord drive component 70. Thus, the following is provided merely as a non-limiting representative embodiment of the present invention.

As shown in FIGS. 2A-2C, the middle portions of tilt cords 50 and 60 remain in contact with the apexes of groove 72 when cord drive component 70 is rotated. In particular, the middle portions of tilt cords 50 and 60 remain in contact with the distal apex of groove 72, and the middle portion of tilt cord 60 also remains in contact with the proximal apex of groove 72. When anchor end 52 is rotated to the left-hand position, a portion of tilt cord 50 is released from groove 72 and a portion of tilt cord 60 is drawn into groove 72 thereby resulting in the simultaneous lowering of distal edge 42 and the raising of proximal edge 44 of blind slat 40. In other words, blind slat 40 is rotated in a counter-clockwise direction. As proximal edge 44 is raised, distal edge 42 is lowered and swings in proximal direction 77 to a position approximately under the proximal position of proximal edge 44. This repositioning of distal edge 42 causes tilt cord 50 to slide in proximal direction 77 across axle 23.

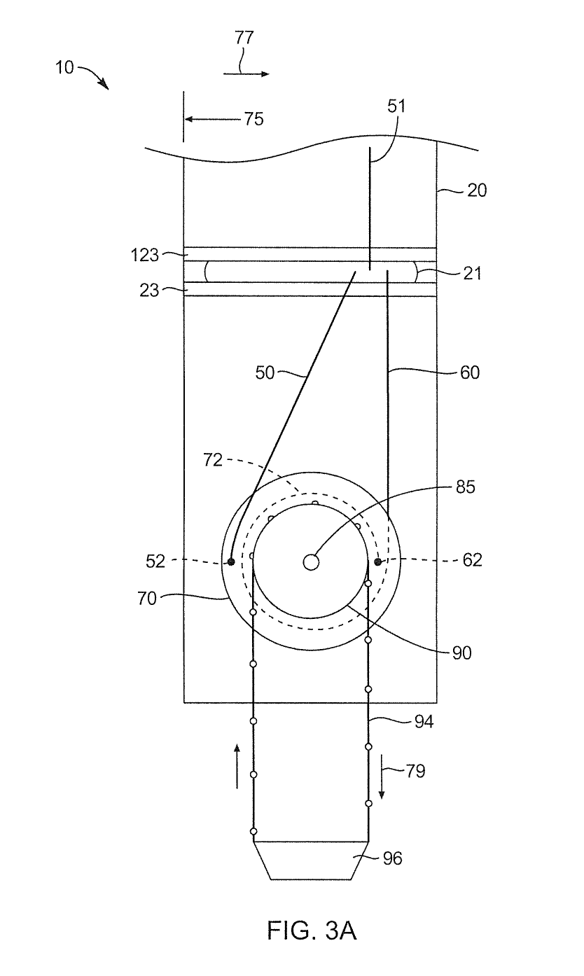

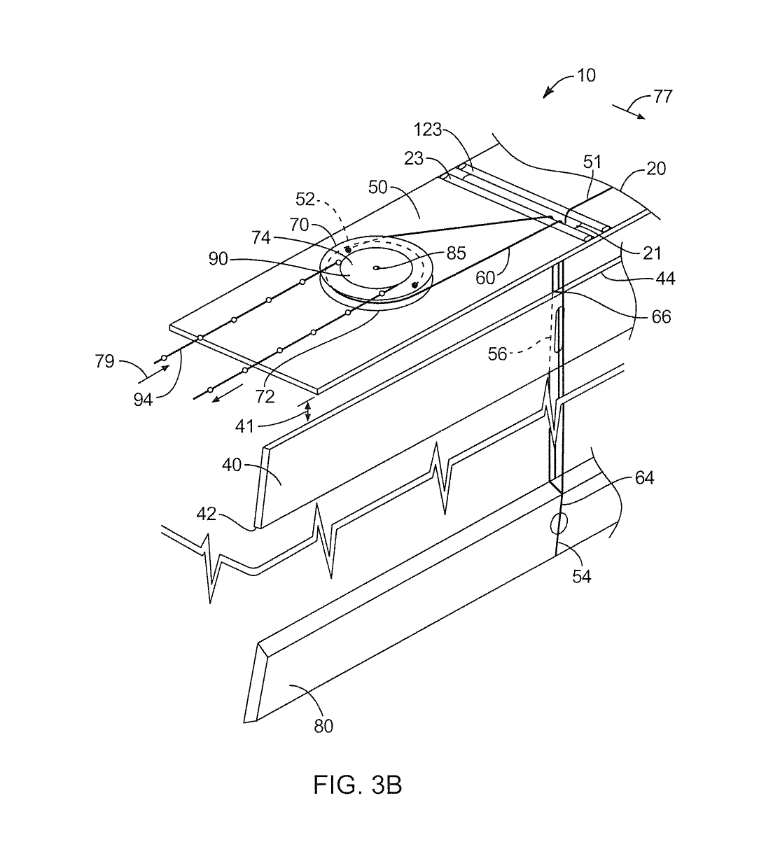

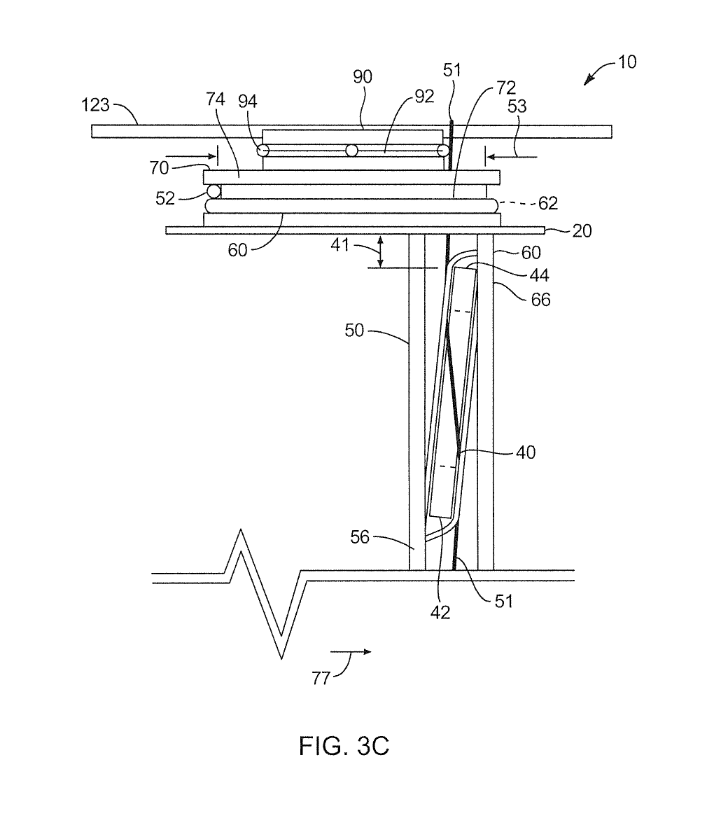

Upon further rotation of cord drive component 70 in clockwise direction 79, anchor end 62 is positioned at the proximal apex of groove 72, and anchor end 52 is positioned at the distal apex of groove 72, as shown in FIGS. 3A-3C. In this configuration, tilt cords 50 and 60 are maximally slid in distal direction 77 on axle 23 and blind slats 40 are in a closed configuration. As such, blind slat 40 is fully positioned under the distal edge of plate 20. Further, distal edge 42 of blind slat 40 is maximally distanced from plate 20, and blind slat 40 is in a generally vertical orientation with respect to the generally horizontal orientation of plate 20.

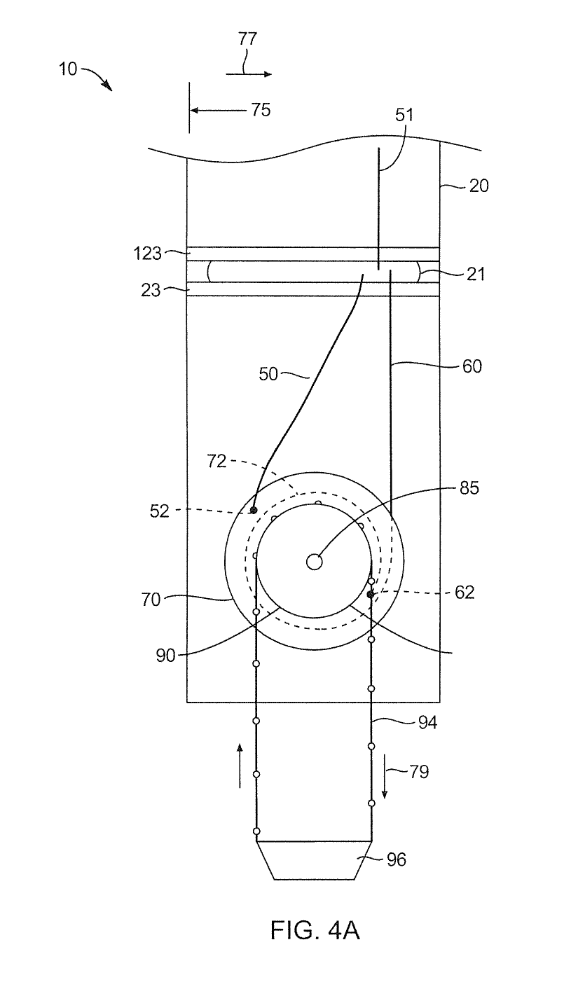

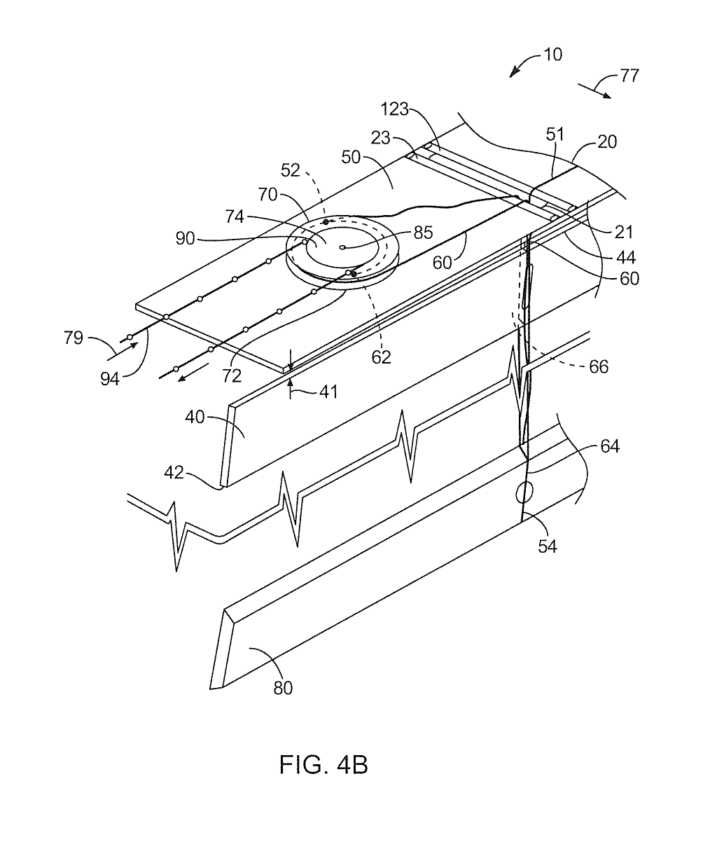

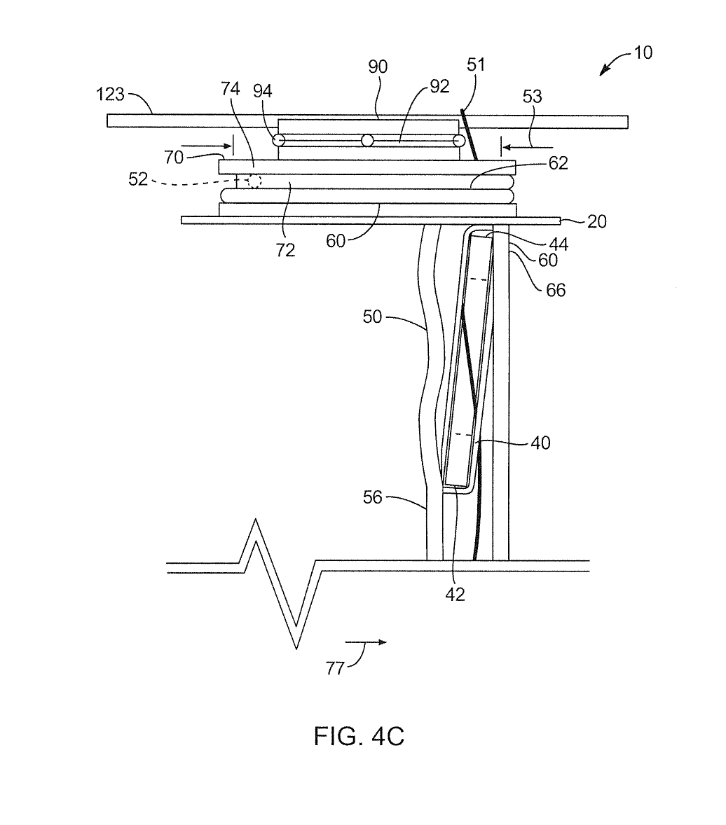

In some embodiments, the position of blind slat 40 in FIGS. 3A-3C results in a small gap 41 between proximal edge 44 and the underside of plate 20. Gap 41 may be undesirable due to light-leakage from the window opening when blind slats 40 are in the closed configuration. Accordingly, in some embodiments gap 41 may be closed by further rotating cord drive component 70 in clockwise direction 79, as shown in FIGS. 4A-4C.

Referring now to FIGS. 4A-4C, head rail 10 is shown with cord drive component 70 in an over-rotated configuration. Upon over-rotation of cord drive component 70 in clockwise direction 79, anchor end 62 is rotated past the proximal apex of groove 72 and to a position between the proximal apex and the left-hand position. Similarly, upon over-rotation of cord drive component 70 in clockwise direction 79, anchor end 52 is rotated past the distal apex of groove 72 and to a position between the distal apex and the right-hand position. This over-rotation results in an additional length of tilt cords 50 being unwound from groove 72, and an additional length of tilt cord 60 being wound onto groove 72 of cord drive component 70. At the point in which anchor end 62 is rotated past the proximal apex of groove 72, proximal edge 44 of blind slat 40 is raised towards plate 20, thereby closing gap 41. Further, at the point in which anchor end 52 is rotated past the distal apex of groove 72, tilt cord 50 becomes flaccid as proximal edge 44 is raised towards plate 20. The flaccid status of tilt cord 50 permits distal edge 42 of blind slat 40 to hang freely and assume a maximally closed position. This over-rotation thereby results in superior closure of the blind slats.

By winding additional tilt cord 60 onto groove 72, the distance between proximal edge 44 and plate 20 is decreased, thereby closing gap 41. In some embodiments, belt drive 94 and rotating device 96 further comprise a cord retention mechanism to maintain a desired degree of rotation for cord drive component 70.

One having skill in the art will appreciate that low profile head rail 10 may work in the opposite direction by simply rotating cord drive component 70 in a counter-clockwise direction. Thus, in some embodiments blind slats 40 may be tilted in a clockwise direction by rotating cord drive component 70 in a counter-clockwise direction. The specifics regarding the motion of tilt cord 50, tilt cord 60, anchor end 52, and anchor end 62 are thus reversed thereby resulting in a closed orientation for blind slats 40 where distal edge 42 abuts the underside of plate 20, and tilt cords 50 and 60 are slid in a distal direction on axle 23 to align in a closed configuration generally under the distal edge of plate 20. Thus, by rotating cord drive component 70, blind slats 40 are simultaneously tilted and slid along axle 23 to reside at either a proximal position or a distal position under plate 20 of the head rail 10.

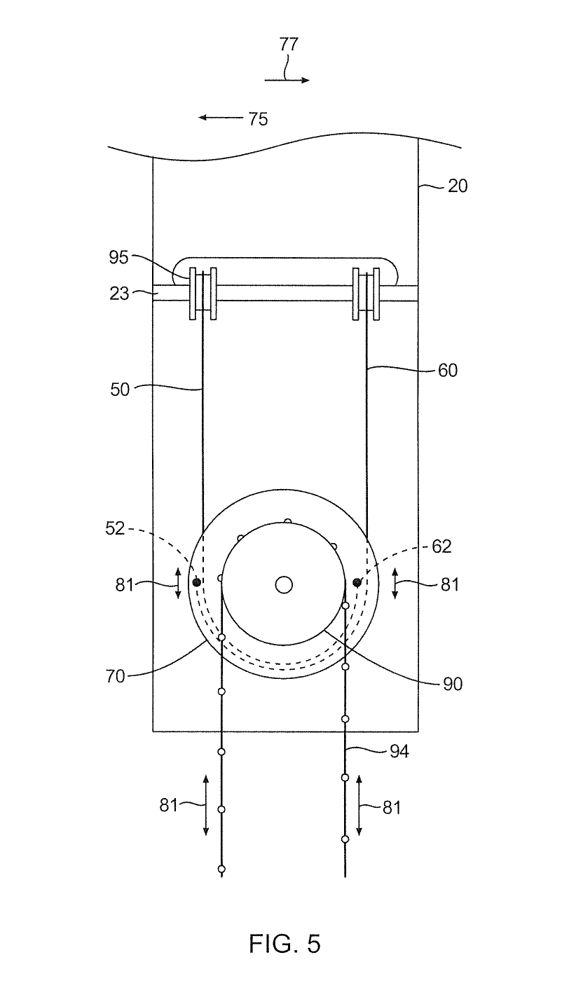

Some embodiments of the present invention further includes a cord support comprising a set of guides 95 which are rotatably threaded onto axle 23, as shown in FIG. 5. Guides 95 each comprises an annular groove that is configured to receive a middle portion of tilt cords 50 and 60. Guides 95 assist in movement of tilt cords 50 and 60 over axle 23 in forward and rearward directions 81 during rotation of cord drive component 70. Guides 95 further assist in movement of tilt cords in distal 77 and proximal 75 directions as the angular positions of anchor ends 52 and 62 change during rotation of cord drive component 70. Guides 95 may comprise any material compatible for use with a window covering. For example, in some embodiments wheels 95 comprise a polymer material, such as nylon or other suitable thermoplastic. In other embodiments wheels 95 comprise a metallic material. Further, in some instances wheels 95 comprises a combination of polymer and metallic materials.

Referring now to FIGS. 6A and 6B, in some embodiments a head rail 100 is provided comprising a plate 120 having a plurality of pulleys interconnected via a plurality of belt drives. For example, in some embodiments a low profile head rail 100 is provided comprising a first cord drive component 70a is coupled to a first and second tilt cord 50a and 60a which are seated on wheels 95 of a first axle 23a. The first and second tilt cords 50a and 60a are fed through a first opening 21a in plate 120 and are coupled to a set of blinds (not shown) suspended below plate 120. Plate 120 further comprises a second cord drive component 70b that is coupled to a third and fourth tilt cord 50b and 60b which are similarly seated on wheels 95 of a second axle 23b. The third and fourth tilt cords 50b and 60b are fed through a second opening 21b in plate 120.

The independent rotations of first and second pulleys 70a and 70b are coordinated via a second belt drive 94b which is coupled to a first and second synchronizing pulley 90a and 90b. In some embodiments, cord drive component 70 may comprise a first synchronizing pulley 90a having a first groove 91a and a second groove 93a to facilitate in coordinated rotation of adjacent pulleys. Thus, as belt drive 94a is turned to rotate cord drive component 70a, belt drive 94b is also rotated thereby synchronizing the rotations of the pulleys 70a and 70b. In some embodiments, synchronizing pulley 90b further comprises a third belt drive 94c that is coupled to a synchronizing pulley of a downstream pulley (not shown). Thus, some embodiments of the present invention may include any number of components desired to provide a window covering.

In some embodiments, additional belt drives may be replaced with a single cam arm 130, as shown in FIG. 6C. Cam arm 130 may include pivot points 132 and 134 to permit full synchronized rotation of pulleys 70a and 70b. Additional pulleys may be coupled together by extending and coupling cam arm 130 to the additional pulleys.

In some implementations, a low profile head rail 250 is provided comprising a plate 20 having a bottom surface 26 on which the various components of the head rail are coupled and oriented to provide an inverted head rail configuration, as shown in FIG. 6D. For example, in some embodiments bottom surface 26 comprise one or more cord drive components 70 rotatably coupled to plate 20 in a horizontal configuration. Tilt cords 50 and 60 are supported via a cord supports 123 that also suspended from bottom surface 26. Cord drive components 70 are rotated via belt drives 94 to change the distance between the cord drive component 70 and a second end of the tilt cords which are attached to blind slats suspended beneath plate 20.

Referring now to FIG. 7, a low profile head rail 270 is shown. In some embodiments, head rail 270 comprises a plate 220 having a distal face 222 and a proximal face 224 thereby providing a u-channel cross sectional profile. Distal and proximal faces 222 and 224 are provided to conceal the various components of the head rail 270. In some embodiments, the horizontal orientation of cord drive component 70 permits head rail 270 to have an overall height that is less than 0.5 inches. As such, low profile head rail 270 may be installed without requiring a valance or other device to conceal head rail 270.

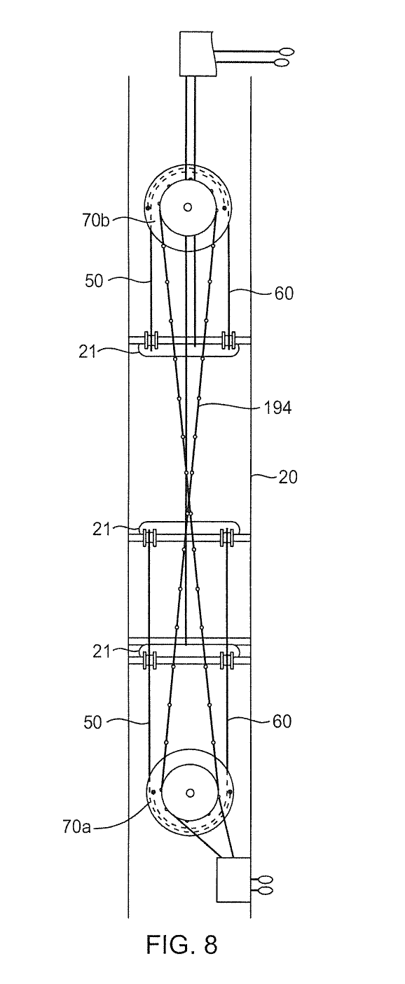

Some embodiments of the present invention include various belt drive configurations that provide benefits over other belt drive configurations. For example, with reference to FIG. 8, in some embodiments a drive belt 194 is provided in a figure-eight configuration to accommodate left and right placement of cord drive components 70 on plate 20, with respect to the relative placement and orientation of openings 21. The figure-eight configuration of drive belt 194 permits cord drive component 70a to be rotated in a clockwise direction while simultaneously rotating cord drive component 70b in a counter-clockwise direction, thereby simultaneously releasing tilt cords 50 and retracting tilt cords 60 to coordinate the counter-clockwise rotation of blinds slats suspended below.

In FIGS. 9A and 9B, drive belt 294 shares groove 72 with tilt cords 50 and 60, thereby eliminating the need for a synchronizing pulley. In some instances, tilt cords 50a and 60a are attached to positions on cord drive device 70a adjacent opening 21a, wherein tilt cords 50a and 60a pass through opening 21a and are coupled to blind slats 40 suspended beneath plate 20. Further, in some embodiments tilt cords 50b and 60b are coupled to positions on cord drive device 70b at positions 73a and 73b, which positions are proximate to the distal and proximal apexes of cord drive component 70b when blind slats 40 are oriented in a neutral position. A second end of tilt cords 50b and 60b pass through opening 21b and are attached to the blind slats 40. Thus, drive belt 294 synchronizes the rotations of cord drive components 70a and 70b thereby simultaneously changing the distance between the cord drive components and the second ends of the tilt cords to rotate the blind slats. With reference to FIG. 9C, a low profile head rail is shown in an inverted configuration, wherein the head rail, cord drive components, drive belts and tilt cords function in a similar to the function of the device shown and described in FIGS. 9A and 9B.

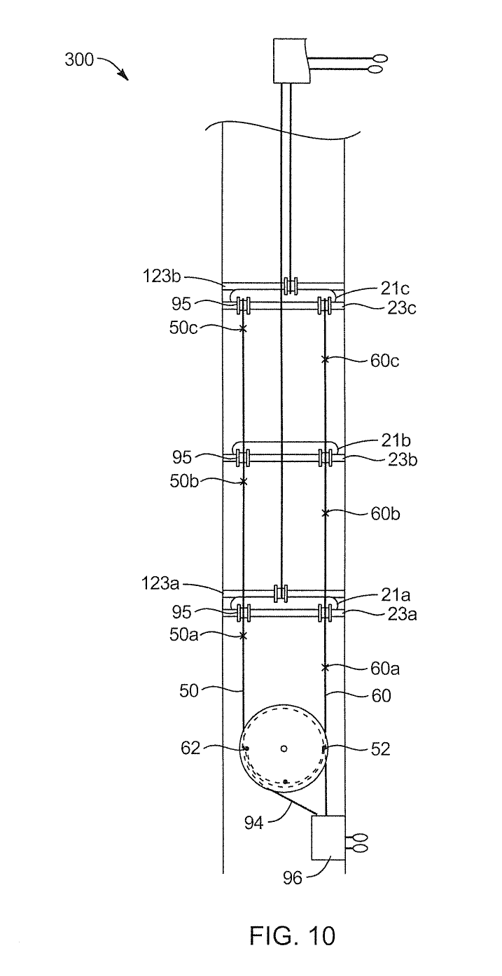

Referring now to FIG. 10, in some embodiments a low profile head rail 300 is provided which comprises a single cord drive component 70 that is configured to simultaneously adjust a plurality of tilt cords (50, 50a, 50b, 60, 60a, and 60b) in a synchronized manner to achieve blind rotation. In some embodiments, head rail 300 comprises a single cord drive component 70 that turned in clockwise and counter-clockwise directions via a drive belt and a tilting mechanism. Cord drive component 70 further comprises a groove or other surface that is configured to receive and retain anchor ends of tilt cords 50 and 60.

Tilt cords 50 and 60 extend outwardly from cord drive component 70 and along the length of plate 20 in a plane that is approximately parallel the top surface of plate 20. Extension tilt cords are coupled to tilt cords 50 and 60 at various locations along the length of the respective tilt cords. For example, in some embodiments tilt cord 50 comprises two extension tilt cords; one extension tilt cord being coupled to tilt cord 50 at point 50a and a second extension tilt cord being coupled at point 50b. Similarly, tilt cord 60 comprises two extension tilt cords coupled at points 60a and 60b. The extension tilt cords branch off of their respective tilt cords and pass over cord supports or guides 95 and exit through openings 21a and 21b in plate 20. The terminal ends of tilt cords 50 and 60 continue past openings 21a and 21b thereby passing over addition cord supports and exiting through opening 21c. The terminal ends of tilt cords 50 and 60, as well as the terminal ends of extension tilt cords 50a, 50b, 60a, and 60b are coupled to a blind slat positioned under plate 20 to achieve synchronized tilting, pivoting or rotating of the blind slat as cord drive component 70 is rotated. In some embodiments, a series of extension tilt cords are coupled directly to the terminal ends of the ladders that are configured to support a plurality of blind slats suspended under the plate of the low profile head rail. Thus, a single cord drive component may be utilized to provide synchronized tilting of a plurality of tilt cords on a single plate. In other embodiments tilt cords 50a, 50b, 50c, 60a, 60b, and 60c are all directly connected to a single cord drive component 70. One having skill in the art will also recognize that there are many connection configurations that allows for tilt cords 50 and 60 to be coupled either directly or indirectly to rotating cord drive component 70.

Referring now to FIGS. 11A and 11B, in some embodiments a grommet 210 is inserted into opening 21. Grommet 210 is used as a cord support for cords 50 and 60, thereby permitting cords 50 and 60 to pass through plate 20 in a protected manner. As such, contact between cords 50 and 60 and plate 20 is prevented.

Referring now to FIGS. 12A and 12B, in some embodiments plate 20 further comprises a grommet 211 having multiple openings. Grommet 211 is inserted into opening 21 and is used as a cord support for cords 50 and 60 to pass through plate 20 in a protected manner. Tilt cords 50, and 60 and lift cord 51 pass through individual openings in grommet 211, as shown.

It is underscored that the present invention may be embodied in other specific forms without departing from its spirit or essential characteristics. The described embodiments herein should be deemed only as illustrative.

What is claimed is:

1. A system for rotating a blind slat, the system comprising:
a plate;
a cord drive component rotatably coupled to the plate in a horizontal configuration; and
a tilt cord having a first end, a second end, and a middle portion extending therebetween, the first end being attached to the cord drive component, the second end being attached to the blind slat, and the middle portion passing through a hole in the plate, wherein the cord drive component is rotated to change a distance between the cord drive component and the second end of the tilt cord.

2. The system of claim 1, further comprising a second tilt cord having a first end, a second end, and a middle portion extending therebetween, the first end of the second tilt cord being attached to the cord drive component, the second end of the second tilt cord being attached to the blind slat, and the middle portion of the second tilt cord passing through the hole in the plate, wherein rotation of the cord drive component in a first direction increases the distance between the cord drive component and the second end of the tilt cord and simultaneously decreases a distance between the cord drive component and the second end of the second tilt cord to tilt the blind slat in a clockwise direction.

3. The system of claim 2, wherein rotation of the cord drive component in a second direction decreases the distance between the cord drive component and the second end of the tilt cord and simultaneously increases the distance between the cord drive component and the second end of the second tilt cord to tilt the blind slat in a counter-clockwise direction, wherein the second direction is opposite the first direction.

4. The system of claim 1, further comprising a plurality of blind slats, a plurality of tilt cords, a plurality of cord drive components, and a plurality of holes operably coupled to the plate.

5. The system of claim 1 further comprising a second tilt cord having a first end and a second end, the first end of the second tilt cord being fixedly coupled to the plate and the second end of the second tilt cord being coupled to the blind slat, the second tilt cord maintaining a fixed distance between the second end of the second tilt cord and the plate, wherein the cord drive component is rotated to change a distance between the cord drive component and the second end of the tilt cord to pivot a plane of the blind slat relative to the fixed position of the second end of the second tilt cord.

6. The system of claim 1, further comprising an axle coupled to the plate in proximity to the hole and configured to support the middle portion of the tilt cord through the hole without causing the middle portion of the tilt cord to contact the plate.

7. The system of claim 6, further comprising a guide rotatably coupled to the axle and having a surface for receiving the middle portion of the tilt cord.

8. The system of claim 1, wherein the plate comprises a head rail having a low profile.

9. The device of claim 1, further comprising a belt drive coupled to the cord drive component, wherein the belt drive facilitates rotation of the cord drive component in clockwise and counter-clockwise directions.

10. The device of claim 9, further comprising a second cord drive component coupled to the top planar surface of the cord drive component, the second cord drive component having a second annular groove for receiving the belt drive.

11. The device of claim 2, further comprising an axle having a first end, a second end, and a length extending therebetween, the axle being coupled to the plate at a position between the cord drive component and the hole in the plate, the axle approximately spanning the width of the hole.

12. The device of claim 11, further comprising a first wheel a second wheel, the first and second wheels being slidably threaded onto the axle and moveable between the first and second ends of the axle along the length of the axle, wherein the middle of the first tilt cord is seated within a groove of the first wheel and the middle of the second tilt cord is seated with a groove of the second wheel.

13. The device of claim 12, wherein an orientation of the first and second wheels is approximately perpendicular to the orientation of the cord drive component.

14. The device of claim 9, further comprising a plurality of cord drive components rotatably coupled to the top surface of the plate.

15. The device of claim 14, further comprising a plurality of belt drives coupled to the plurality of cord drive components to facilitate rotation of the plurality of cord drive components in clockwise and counter-clockwise directions.

16. The device of claim 11, further comprising a plurality of cord drive components rotatably coupled to the top surface of the plate, each of the cord drive components further comprising a synchronizing pulley coupled to the top planar surface of the cord drive component, each synchronizing pulley having a second annular groove for receiving a belt drive to facilitate synchronized rotation of the plurality of cord drive components in clockwise and counter-clockwise directions.

17. The device of claim 1, wherein the plate further comprises a front sidewall and a rear sidewall, each sidewall having a height that is approximately equal to a height of the cord drive component.

18. A method for tilting a horizontal blind, the method comprising:
providing a window covering having a head rail comprising:
a plate having a top surface, a bottom surface, a length, and a width;
a cord drive component having a top planar surface, a bottom planar surface, and an annular groove disposed therebetween, the cord drive component being rotatably coupled to the plate in a generally horizontal configuration such that the bottom planar surface is oriented towards the top surface of the plate and the top planar surface is opposite the bottom planar surface and is oriented away from the top surface of the plate;
a first tilt cord having an anchor end, a terminal end, and a middle extending therebetween, the anchor end of the first tilt cord being fixedly coupled to the annular groove at a first position, the middle of the first tilt cord being configured to pass through an opening in the plate, and the terminal end of the first tilt cord being configured to attach to a proximal edge of a blind slat; and
a second tilt cord having an anchor end, a terminal end, and a middle extending therebetween, the anchor end of the second tilt cord being fixedly coupled to the annular groove at a second position, the second position being approximately opposite of the first position, the middle of the second tilt cord being configured to pass through the opening in the plate, and the terminal end of the second tilt cord being configured to attach to a distal edge of the blind slat; and
rotating the cord drive component to wrap a portion of the middle of the first tilt cord within the annular groove and simultaneously unwrap a portion of the middle of the second tilt cord from within the annular groove, thereby causing the proximal edge of the blind slat to move towards the bottom surface of the plate while simultaneously causing the distal edge of the blind slat to move away from the bottom surface of the plate.

19. The method of claim 18, further comprising a step for over-rotating the cord drive component to wrap an addition portion of the middle of the first tilt cord within the annular groove and simultaneously wrap a portion of the middle of the second tilt cord within the annular groove, the middles of the first and second tilt cords simultaneously occupying a same portion of the annular groove, wherein the over-rotation draws the proximal edge of the blind slat towards the bottom surface of the plate.

20. A system for rotating a blind slat, the system comprising:
a plate having a top surface and a bottom surface, the top surface being configured for attachment to a window opening;
a cord drive component rotatably coupled to the bottom surface of the plate in a horizontal configuration; and
a tilt cord having a first end attached to the cord drive component, and a second end attached to a blind slat suspended below the plate, wherein the cord drive component is rotated to change a distance between the cord drive component and the second end of the tilt cord to rotate the blind slat in clockwise and counter-clockwise directions.
